(19) United States
(12) Patent Application Publication
(10) Pub. No.: US 2026/0253048 A1
(43) Pub. Date: Aug. 27, 2026

(54) METHOD AND SYSTEM FOR FACILITATING SOCIAL INTERACTIONS THROUGH A SELECTIVE AVAILABILITY MECHANISM

(71) Applicant: D2C Holdings LLC, Ann Arbor, MI (US)

(72) Inventors: Vladyslav Slyusar, Northville, MI (US); Denys Slyusar, Northville, MI (US); Nicholas Tennant, Fort Lauderdale, FL (US); Spiro Vamvakas, Birmingham, MI (US)

(73) Assignee: D2C Holdings LLC, Ann Arbor, MI (US)

(21) Appl. No.: 19/547,054

(22) Filed: Feb. 23, 2026

Related U.S. Application Data
(60) Provisional application No. 63/761,891, filed on Feb. 22, 2025.

(51) Int. Cl. G06Q 10/42; G06Q 10/1093

(52) U.S. Cl. CPC G06Q 10/42; G06Q 10/1093

(57) ABSTRACT

A method and system for facilitating social interactions through a selective availability mechanism in a social media application allows users to activate an availability toggle feature, which displays their availability only to a pre-selected group of friends. Additionally, mood categorization features can enhance user engagement by allowing individuals to express their emotional states, thereby promoting in-person connections based on shared interests. The system can incorporate complementary features such as real-time friend availability, instant group formation, mood-based meetup facilitation, and activity-based friend discovery, promoting and facilitating spontaneous and meaningful social interactions by allowing users to discreetly indicate their openness to in-person engagements.

### CROSS-REFERENCE TO RELATED APPLICATIONS

This application claims priority to U.S. Provisional Patent Application No. 63/761,891, filed February 22, 2025, and which is incorporated herein by reference in its entirety.

### FIELD OF THE DISCLOSURE

The present invention relates to social networking applications and, more specifically, to a method and system for indicating a user’s availability for in-person interactions using a non-intrusive selective availability mechanism. This system enhances user engagement by allowing seamless and spontaneous social connections based on real-time availability and user preferences

### BACKGROUND OF THE DISCLOSURE

Social media platforms have revolutionized how individuals connect and communicate. Existing applications facilitate online interactions through messaging, status updates, and notifications but often lack mechanisms for promoting causal, in-person engagements. Traditional systems rely heavily on direct notifications or invitations, which can feel intrusive and may discourage users from initiating interactions.

Numerous studies have demonstrated that social connections significantly contribute to overall life satisfaction. However, facilitating these connections is not without challenges. Social interactions typically involve various costs that can hinder frequent and meaningful engagements. These include the time, attention, and financial cost associated with organizing and attending social gatherings, which can be burdensome for individuals with busy schedules or limited means.

Additionally, there is a need for social media platforms that can reduce social anxiety and interpersonal conflicts associated with organizing and facilitating social interaction and events.

Time allocated to unwanted or uninvited socializing is time diverted from personal, professional, or other social activities, potentially limiting the breadth and depth of an individual’s engagements.

Diverse communication styles, hospitality norms, levels of formality, and social hierarchies across different cultures can complicate spontaneous interactions, making them less accessible and uncomfortable for some users.

These factors highlight a need for a solution that mitigates the costs associated with facilitating social interactions by expanding the social circle (i.e., friends) from which users may choose to interact, while also providing mechanisms for reducing or filtering undesired or inconvenient interactions when desired. The absence of such a mechanism can lead to missed opportunities for spontaneous socialization, thereby reducing user engagement and satisfaction within social networks.

### SUMMARY OF THE DISCLOSURE

The disclosed methods and applications incorporate an availability toggle button or switch that allows users to indicate their readiness for in-person interactions discreetly. This feature serves as the core of the system and is complemented by a suite of additional functionalities, including mood categorizations, real-time friend availability, instant group formation, mood-based meetup facilitation, activity-based friend discovery, and more. These complementary features work in synergy to enhance user engagement, facilitate spontaneous meetups, and promote meaningful social interactions based on shared interests and current user states, such as schedule constraints and user mood.

The availability toggle button or switch sends/redacts open invites passively to a preconfigured list, allowing the application to display a list of two-way invitations within overlapping social groups in real time. Both the user and a user’s friend must be toggled to be online with each allowing engagement with the other in order to enable social engagement.

The methods and applications described herein allow users to find out who is currently available for interaction and allows a party/gathering to form from the ground up instead of top down. A small enough group of close friends may not incur much in terms of facilitation cost, but a larger friend circle typically relies on one or more individuals to take a lead role to get in touch with everyone and that involves a lot of back and forth communication. The disclosed methods and applications allow a gathering of any size within a friend group or overlapping friend groups to socialize without the need for a leader or back and forth communication.

By addressing the various costs associated with socializing – such as time, emotional strain, opportunity loss, and cultural barriers – the application offers a low-pressure environment that encourages users to connect more frequently and meaningfully without the typical social costs. This selective availability mechanism empowers users to manage their social interactions proactively, fostering a more satisfying and efficient social experience.

### BRIEF DESCRIPTION OF THE DRAWINGS

FIG. 1 is a process flow diagram illustrating the core features of the method for facilitating social interactions.

FIG. 2 is a flowchart of the contact management system for enabling/disabling friends.

### DETAILED DESCRIPTION

A mobile application designed to facilitate social interactions by providing users with a mechanism to express their availability for in-person meetings in a low-pressure environment is described and claimed. The mobile application can be executed on a mobile electronic device (e.g., a cellular telephone) and is capable of communicating with a social media platform which hosts user data and manages user accounts to provide the infrastructure for interaction. The mobile application can include an availability toggle switch or button that allows users to discreetly signal their readiness for social engagement without intrusive notifications. The toggle switch or button can be any user manipulated device for choosing between two mutually exclusive states or values and is generally displayed on a user interface such as a touch screen. This toggle feature allows the user to indicate availability to only selected members of the social networking service or platform, preferably without providing any indication to non-selected members of the social networking service. Complementary features can enhance this functionality, offering a comprehensive solution for spontaneous and meaningful social interactions.

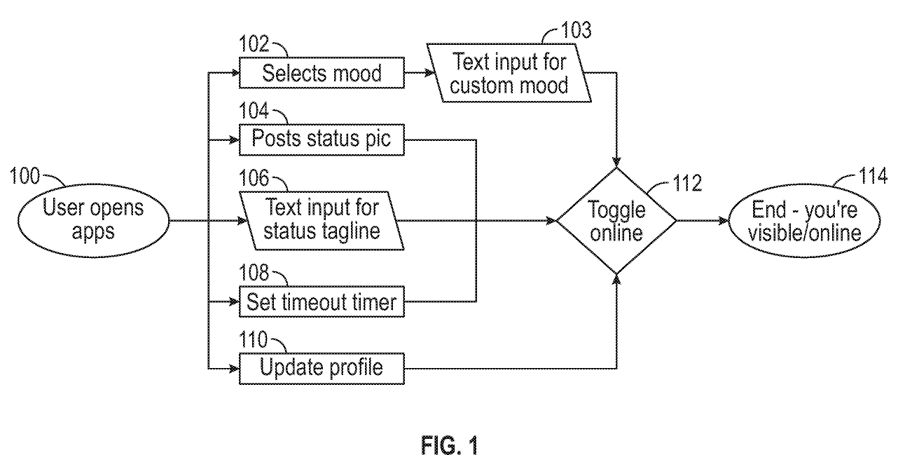

Features of the user interface of the application are illustrated in FIG. 1. After the user opens the application at step 100, the user may select an indication of their mood at option 102, post picture(s) at option 104, input text for a status tagline at option 106, set a timeout timer at option 108, and/or update their user profile at option 110. The user may select from a list of possible moods at option 102 or enter text for a custom mood at option 103. After choosing from among any combination of options 102, 103, 106, 108 and 110, the user can choose to go online at toggle 112 at which time the user will become visible to other users at step 114.

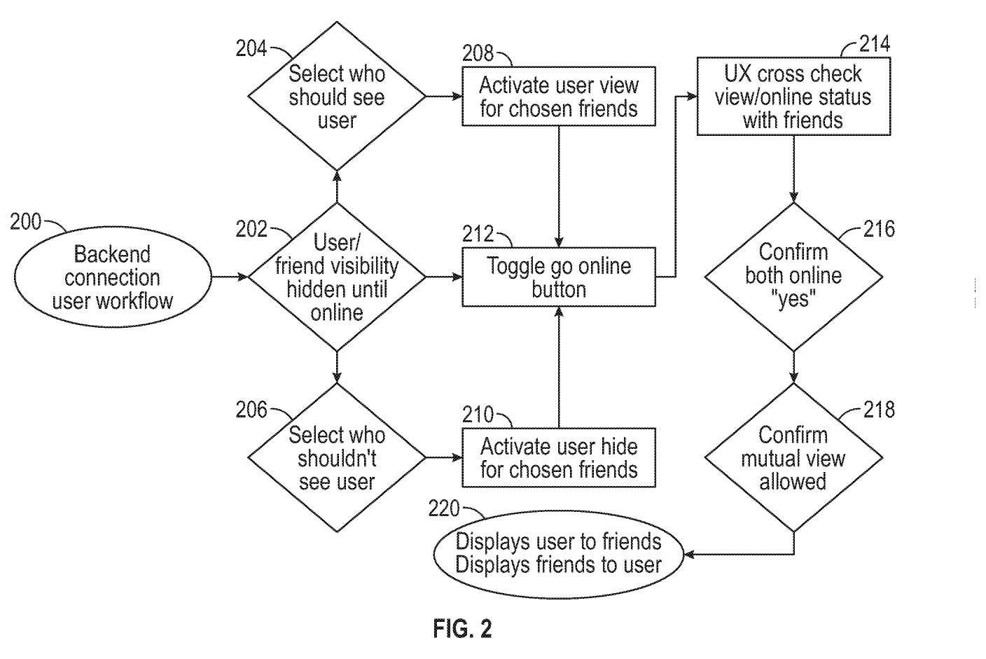

A privacy selection feature is illustrated in FIG. 2. The user can open the privacy selection feature at step 200. At step 202, the user may choose to either select other users that are able to see the user’s availability at step 204 or to choose other users (friends) that are not able to see the user’s availability at step 206. After selecting the other users that can see the user’s availability, the user may finalize their selections at step 208. Alternatively, the user may finalize their selections of other users that cannot see the user’s availability at step 210. The user’s privacy selections can be displayed. Thereafter, the user can select toggle 212 to go online. The application may check whether the selected friends are online at step 214, confirm the selected friends availability at step 216, confirm mutual viewing has been allowed at step 218, and display the available friends at step 220.

The availability toggle feature (e.g., button or switch) can be activated to signal a user’s readiness for social interaction. When activated, the toggle changes the user’s status to “available,” which is visible only to a predetermined list of friends selected by the user. This selective visibility ensures that users can express their availability without feeling pressured by unwanted messages.

The user interface is designed for simplicity and ease of use. The availability toggle feature is prominently displayed, allowing users to switch their availability status with minimal effort. The interface also includes action-oriented buttons for quick navigation and interaction, and mood categorization options that allow users to select their current mood or activity preference.

The application integrates a robust contact management system that enables users to import contacts from their device’s address book. Users can create a customized list of friends who can view their availability status. A checkbox system can be used for allowing various user interface choices such as enabling or disabling friends, going online or offline, and providing full control over visibility settings. Advanced friend filtering based on availability, proximity, and interaction frequency further enhances the management experience.

User can select from multiple predefined mood categories (e.g., study, chill, drink) to accompany their availability status. This optional feature allows users to express their current emotional state or activity preference, fostering connections based on shared interests and enhancing the social engagement experience. Mood categorization is integrated with other features such as meetup facilitation and friend discovery to facilitate more meaningful interactions. The mood categorization is useful for filtering friends and invitations by specific activities. For example, if there are 50 friends currently active on the system, the user can restrict their view to only individuals that toggled “Athletic” and choose to interact from only that list.

In addition to the availability toggle button, the application can include several complementary features or algorithms that enhance its functionality. A real-time friend availability feature can display user availability using mood and preferences with dynamic updates and an intuitive interface. Friends can see when a user is available for interaction, enhancing spontaneous meetups.

An instant group formation feature can enable real-time group management with visibility controls (public, friends-only, or custom). Groups automatically update based on the availability of members, facilitating seamless group interactions.

A mood-based meetup facilitation feature can assist users in planning meetups that align with their current mood and availability. Users can confirm or adjust plans based on their and their friends’ real-time availability and mood states, reducing the need for intrusive notifications and minimizing emotional costs.

An activity-based friend discovery feature can suggest friends based on shared interests, mood, and proximity using an intelligent matching algorithm. This feature helps users discover and connect with friends who are most compatible for specific activities.

A group event management feature can simplify event creation and tracking, integrating with the application’s internal scheduling tools and providing reminders. Users can create group events, track RSVPs, and receive reminders to ensure participation.

A customizable user experience feature can offer personalized themes, avatars, and QR codes for profile sharing. Users can customize their experience to reflect their personality and preferences, enhancing engagement.

A multi-friend meetup interface feature can optimize group plans with dynamic adjustments for time, location, and activity. This interface allows users to coordinate meetups with multiple friends, adjusting plans in real-time based on changes in availability or preferences.

A social readiness algorithm can calculate a readiness score based on user mood and preferences to ease interaction planning. This score helps users gauge the best times and conditions for initiating social interactions.

A social closeness score can be used for sorting a friend list. Interaction through the app with another user increments this score so closer friends show up closer to the top.

A social readiness algorithm can be used to predict user online/offline times based on a friend’s online/offline history.

A mood-based notification filtering application can include standard notification features commonly found in social media apps, primarily used for messaging purposes. These notifications support communication between users.

A group polling system can perform live polls for group decisions with instant updates for all participants. This system allows groups to make collective decisions efficiently, such as choosing activity types or meeting times.

An eyeball privacy control feature can allow real-time visibility toggles for friends or groups based on activity, location, or mood. Users can dynamically adjust their visibility settings to control who can see their status at any given moment.

An event integration with updates feature can connect external events with user plans, dynamically updating availability. Integration with event platforms allows the application to reflect external commitments and adjust availability accordingly.

A social QR system can provide QR codes for linking users via telephones, sharing availability, creating group chats, or initiating meetups. This system facilitates easy sharing of user status and preferences in various social contexts.

A social comfort algorithm can suggest low-pressure activities to reduce social anxiety. This algorithm identifies and recommends activities that are conducive to comfortable social interactions for users who experience social anxiety.

A predictive hangout suggestions algorithm can use AI to predict availability and recommend plans based on behavior and preferences. Predictive analytics help users discover optimal times and activities for meetups without extensive planning.

A connection efficiency score algorithm can analyze interactions to highlight compatible friends. This score helps users identify friends with whom they have the most meaningful connections, promoting deeper social engagements.

An integrated friend map can display friends dynamically filtered by mood or activity. This visual map allows users to see the status and preferences of their friends at a glance, facilitating spontaneous meetups based on real-time data.

The functionality is designed to be integrated into a comprehensive social media application, leveraging all the described features to enhance user interactions and engagement. Potential applications within this social media application include: gamification elements that reward users for engaging in social activities with friends, enhanced event planning and tracking through group event management features, fostering community building and supporting mental well-being through features like the social comfort algorithm, facilitating spontaneous meetups by utilizing real-time availability and mood-based matchmaking, enhancing user engagement through personalized experiences tailored to individual preferences and social behaviors, and promoting meaningful social interactions based on real-time data and user preferences, ensuring connections are both relevant and timely.

These applications within the social platform aim to bypass traditional social barriers, maximize opportunities for interaction, and create a dynamic environment where users can connect effortlessly based on their current states and preferences.

The systems and methods disclosed herein provide an innovative approach to enhancing social interactions through a selective availability mechanism in a social media application. By allowing users to discreetly indicate their openness to in-person engagements without incurring the typical social costs associated with such interactions, the application fosters casual connections and supports user preferences for socializing. The integration of complementary features such as mood categorization, real-time availability, and intelligent group management allows the user to expand their social circle beyond their closest friends to include other users that have shared interests. Such features provide a comprehensive solution that addresses the limitations of existing social networking platforms, promoting spontaneous and meaningful social interactions.

The application allows a large community to see not only each other’s availability but also real-time openness to interaction, social behavior fundamentally changes. Users can expand beyond their closest friends and socialize more broadly. By lowering coordination and facilitation costs, the overall cost of socializing are reduced. The application reduces the effort needed to know who is free and receptive, increasing spontaneous interactions. Users connect more often, reconnect with distant friends, and expand their social scope. At the same time, the application allows a user to prevent unwanted interactions, such as when the user is preoccupied with other activities.

The application requires just one tap to instantly become available for social activities or prevent undesired social interactions.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

1. A method for controlling social interactions via a social media application communicating with a social networking platform, comprising:
displaying, to a user via a graphical user interface on a mobile electronic device, a toggle feature for selecting between indicating availability to all friends listed by the user in the social media application or indicating availability to a selected subset of friends.

2. The method of claim 1, wherein the social media application further comprises a contact management system that enables the user to import contacts from an address book on the mobile electronic device to the friends listed on the social media application.

3. The method of claim 1, wherein the social media application further comprises a mood categorization feature enabling users to express their current emotional state; a real-time friend availability display based on mood and user preferences; an instant group formation with visibility controls and automatic updates based on member availability; and a mood-based meetup facilitation synchronized with user preferences and providing instant notifications.

4. The method of claim 1, wherein the availability toggle feature changes the user’s status to “available” visible only to a predetermined list of friends.

5. The method of claim 2, wherein the contact management system generates an interface allowing the user to select between enabling or disabling a friend to see the user’ availability status.

6. The method of claim 3, wherein the mood categorization includes predefined categories that enhance social matching based on shared interests.

7. The method of claim 1, further comprising a real-time friend availability feature that dynamically updates user availability based on mood and preferences.

8. The method of claim 1, further comprising an instant group formation feature that manages groups in real-time with visibility controls such as public, friends-only, or custom settings.

9. The method of claim 1, further comprising an activity-based friend discovery feature that suggests friends based on shared interests, mood, and proximity using an intelligent matching algorithm.

10. The method of claim 1, further comprising a customizable user experience feature offering QR codes for at least one of profile sharing, availability sharing, creation of group chats, and initiating meetings.

11. The method of claim 1, further comprising a multi-friend meetup interface that optimizes group plans with dynamic adjustments for time, location, and activity.

12. The method of claim 1, further comprising a social readiness algorithm that calculates a readiness score based on user mood and preferences to ease interaction planning.

13. The method of claim 1, further comprising mood-based notification filtering that utilizes standard messaging notifications without emphasizing availability status updates.

14. The method of claim 1, further comprising a group polling system that allows live polls for group decisions with instant updates for all participants.

15. The method of claim 1, further comprising eyeball privacy control with real-time visibility toggles for friends or groups based on activity, location, or mood.

16. The method of claim 1, further comprising event integration with updates that connect external events with user plans, dynamically updating availability.

17. The method of claim 1, further comprising an action-oriented button that simplifies navigation with predefined, customizable action buttons.

18. The method of claim 1, further comprising suggestions using AI to recommend plans based on behavior and preferences.

19. The method of claim 1, further comprising a connection efficiency score that analyzes interactions to highlight compatible friends.

20. The method of claim 1, further comprising an integrated friend map that displays friends dynamically filtered by mood or activity.
